(19) United States
(12) Patent Application Publication
(10) Pub. No.: US 2003/0025002 A1
(43) Pub. Date: Feb. 6, 2003

(54) Pressurizable fluid spray system

(76) Inventor: Jeffrey Hughes, Fremont, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/213,156

(22) Filed: Aug. 5, 2002

Related U.S. Application Data
(60) Provisional application No. 60/310,264, filed on Aug. 4, 2001.

(51) Int. Cl. B05B 7/30

(52) U.S. Cl. 239/340

(57) ABSTRACT

A pressurized fluid spraying apparatus including a sprayer and separate manual two stage pump. The sprayer preferably includes a three way valve capable of performing the function of a pump coupling for connecting to the pump to pressurize the pressure chamber, a pressure release valve, and a safety valve. In some embodiments, the pressure chamber is preferably capable of holding air pressure of at least 300 psi, in other embodiments, 1,000 psi, and in still other embodiments 2,000 psi. A re-useable fluid container is accepted within the sprayer and may be easily switched to change fluids. The two-stage pump may be configured to allow pumping of air under high pressure into the pressure chamber in the sprayer. The pump is preferably manually operated, but could be powered in alternate embodiments.

### FIELD OF THE INVENTION

The present invention relates generally to pressurizable systems for spraying fluids.

### BACKGROUND OF THE INVENTION

Many kinds of fluid spraying apparatus and systems exist. However, prior systems have various limitations. For example, powered airless sprayers require a pump typically run using electricity. This requires a cord that is run to a nearby outlet or power source, which may not be convenient or accessible. Cordless spray systems exist, but such sprayers frequently require expensive and heavy batteries. In addition, sprayers are typically used continuously for long periods of time. Thus, battery powered devices are not generally suited for use in sprayers because frequent battery changes or recharging would be required.

Some existing powerless spray systems include a container that is pressurizable using a manual sir pump mounted on the spray device. However, the pressure that can be achieved in these devices is limited, and such devices are not suited for spraying thick fluids because the pressure is generally not sufficient to atomize the fluid, nor are such devices suited for use in spraying large surface areas, because frequent re-pressurization is required when these devices are sprayed continuously. In addition the inclusion of pumping apparatus on the sprayer increases the weight of the sprayer, which makes the sprayer less convenient to use.

Pre-pressurized sprayers such as aerosol cans are often used. However, aerosol cans are not typically re-useable, and contain only a small amount of paint.

What is needed is a pressurizable paint spraying system that is capable of spraying fluid like an airless sprayer, and does not require hoses or access to a power source, that is capable of using either re-useable or disposable paint containers in order to reduce the amount of cleaning required, and that is suitable for both small and moderately sized spray applications.

### SUMMARY OF THE INVENTION

In accord with the present invention is disclosed a portable hand held pressurizable fluid sprayer including a housing and a spray apparatus. In some embodiments, the spray system it is capable of spraying fluids of varying viscosity. In other embodiments, the spray system does not require hoses or access to an electrical power source. In further embodiments the spray system is capable of using either reuseable or disposable paint containers in order to reduce the amount of cleaning required. In still other embodiments, the spray system is suitable for both small and moderately sized spray applications.

The pressure chamber is configured to accept a fluid container. The housing preferably also includes one or more valves capable of performing the function of a pump coupling for connecting to the pump to pressurize the pressure chamber, a pressure release valve, and a safety valve. In some embodiments the pump coupling is a quick release coupling located on the bottom of the housing. The housing preferably includes some means for releasably locking onto the pump assembly, and a second means for releasably coupling to a spray assembly. In some embodiments, the pressure chamber is preferably capable of holding air pressure of at least 150 psi, in more preferred embodiments 300 psi, in other preferred embodiments, 1,000 psi, and in still other preferred embodiments 2,000 psi.

The fluid container is preferably re-useable, but replaceable so that the fluid being sprayed may be easily switched by simply switching the fluid container. In some embodiments the fluid container may be disposable. The fluid container is configured to be received within the pressure chamber. The fluid container includes a bucket portion and a lid. The lid of the fluid container preferably includes a first opening, to which a siphon tube is attached. A second opening or valve is preferably present in the fluid container to allow pressure equalization between the pressure chamber and the interior of the fluid container. The siphon tube is preferably configured so that the end opposite the lid of the container can bend, swivel, or pivot as the sprayer is tipped so as to remain at the deepest point in the fluid container.

The spray assembly is coupled to the top of the housing, and the spray assembly is in fluid communication with the siphon tube of the fluid container. The spray assembly preferably includes a handle.

The invention may also include a separate two-stage pump configured to allow pumping of air under high pressure into the pressure chamber in the housing of the sprayer. The pump is preferably manually operated, but could be powered in alternate embodiments.

Some embodiments of the invention use a single three-way valve rather than separate pump coupling, pressure release, and a safety valves.

### DESCRIPTION OF THE DRAWINGS

FIG. 1 shows a cutaway side view of an embodiment of a spray apparatus.

FIG. 2 shows an exploded view of the spray apparatus embodiment of FIG. 1.

FIG. 3 shows a perspective view of an embodiment of the housing.

FIG. 4 shows a cutaway side view of the housing of FIG. 3.

FIG. 5 shows an exploded view of an embodiment of the container

FIGS. 6a and 6b show a top and bottom perspective view of the container of FIG. 6 with a transparent cup.

FIG. 7 shows a cutaway side view of an embodiment of the spray gun.

FIG. 8 shows an exploded view of a three-way valve configured in accord with the invention.

FIG. 9 shows a side view of an embodiment of the three way valve.

FIG. 10 shows a cross-sectional view taken along line 10-10 of FIG. 9.

FIG. 11 shows a top view of an embodiment of the inner housing of the three way valve.

FIG. 12 shows a perspective view of an embodiment of the inner housing of the three way valve.

FIG. 13 shows a perspective view of an embodiment of the pump assembly.

### DETAILED DESCRIPTION

One aspect of the present invention is a portable pressurizable fluid spray system. In some embodiments, the spray system it is capable of spraying fluids of varying viscosity. In most embodiments, the spray system does not require hoses or access to an electrical power source. In some embodiments the spray system is capable of using either re-useable or disposable paint containers in order to reduce the amount of cleaning required. In still other embodiments, the spray system is suitable for both small and moderately sized spray applications. Some embodiments of the invention are capable of operation at high pressure. “High pressure” is defined herein as air pressure above 300 psi. The meaning of the term “fluid” as described herein includes a substance (such as a liquid or gas) that tends to flow or conform to the outline of its container.

One embodiment of the spray system of the invention is particularly suited for spraying paints and varnishes. However, the invention is not limited to such use. One aspect of some embodiments of the invention disclosed herein is that the design in easily adaptable for use spraying fluids with relatively low viscosity (such as thin paints and varnishes) and also spraying fluids with relatively high viscosity (such as thick paints and adhesives). Embodiments of the sprayer disclosed herein may be configured to spray virtually any kind of fluid, including fluids of high viscosity, including but not limited thick paints, heavy oils, and adhesives. In some embodiments the spray system of the invention may even be used to spray powders.

Increases in the viscosity of the fluid to be sprayed required larger increases in the pressure used to spray the fluid. Therefore, embodiments of the spray system of the invention for spraying fluids of varying viscosity are preferably, but not necessarily, capable of operating at pressures exceeding 2,000 pounds per square inch. Embodiments intended for use spraying only relatively lower viscosity fluids may be configured to operate only at lower pressures. Thus the preferred ranges of operation include operation at air pressure below 300 psi, but preferably at air pressure above 300 psi, and in some embodiments more preferably at air pressures above 1,000, and in other embodiments more preferably at air pressures above 2,000 psi.

In general, the spray system includes two major components, the sprayer and the pump. The sprayer is a hand held component that includes a housing featuring a pressure chamber for holding a quantity of substance to be sprayed, and a spray assembly including a lid and a spray gun for controlling the spray of the substance. The pump is preferably manually operated, and is used to pump air into the pressure chamber of the hand held sprayer. The pressurized air is used to push the fluid through the spray tip, which atomizes the fluid. The dimension of the sprayer may be easily varied as necessary by one skilled in the art, however in most embodiments the sprayer is preferably sized for convenient use with on hand, and weighs less than 5 pounds, including the paint contained in the sprayer. The spray system may be fabricated from any acceptable material including various metals, plastics and composite materials. Light weight materials such as aluminum and various plastics are preferred in order to reduce the overall weight of the sprayer. The particular material selected may depend on factors such as the properties of the materials to be used in the sprayer, and the pressure at which the sprayer is designed to operate.

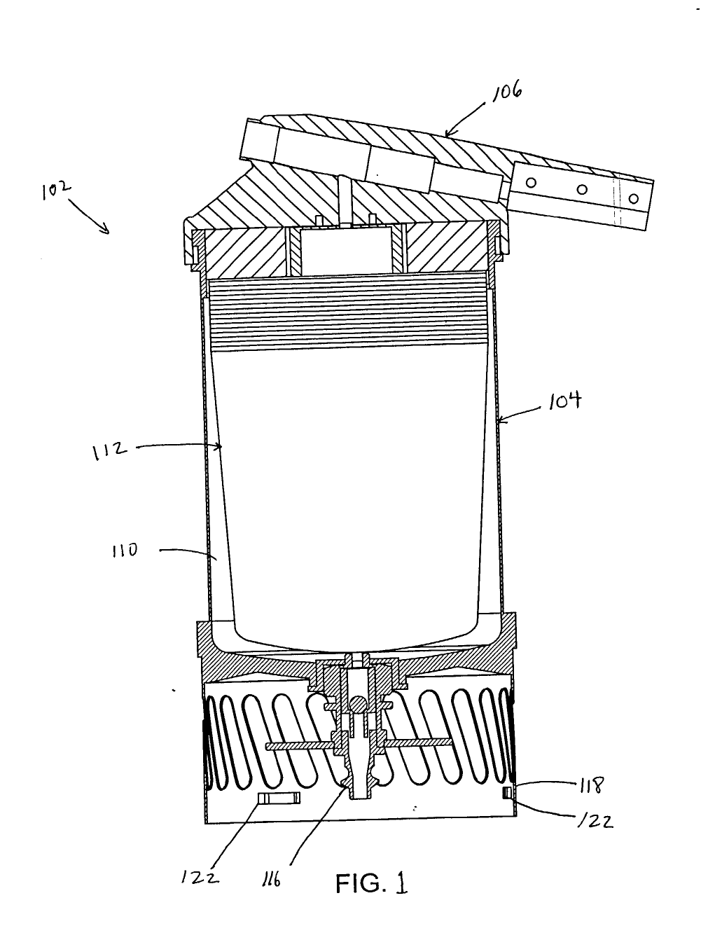

FIG. 1, shows a side cutaway view of one embodiment of the sprayer 102 of the spray system of the invention. The sprayer 102 generally comprises two major parts, the housing 104 and the spray assembly 106. The housing 104 is cylindrical in the embodiment shown, but could be other shapes in alternate embodiments. A pressure chamber 110 is formed in the housing 104 and is configured to accept a container 112.

The housing 104 preferably includes one or more valves, including a valve for coupling to the pump 114 used to pressurize the pressure chamber 110, a pressure release valve that is used to equalize the air pressure between the inside and the outside of the pressure chamber 110 before the fluid container 112 is removed or exchanged, and a safety valve that is selected to release automatically if the pressure in the pressure chamber 110 exceeds a pre-determined safety level. In the embodiment generally shown in the figures, the housing 104 includes a single three-way valve that performs all three valve functions listed above. The three-way valve 116 will be discussed in greater detail further below.

It is preferable that the housing 104 further include some structure for protecting the three-way valve 116 from accidental contact or impact with objects that may damage the valve 116. One example is shown in the embodiments seen in FIGS. 1 through 4, wherein the housing 104 includes a flange or cage 118 intended to protect the three-way valve 116.

Apparatus for coupling the housing 104 securely to a pump 114 are desirable. Many acceptable apparatus for coupling the housing to the pump are known and useable. The cage 118 includes a number of locking protrusions 122 on the inside surface of the cage. As will be discussed later, these features interact with matching features on the pump 114 to allow the housing 104 to be locked into place on the pump 114, with the three-way valve 116 coupled to a nipple on the pump 114 allowing air to be transferred from the pump 114 to the pressure chamber 110 in the housing 104.

In some embodiments the housing 104 may also include a pressure gage to allow the user to monitor the air pressure remaining in the pressure chamber 110.

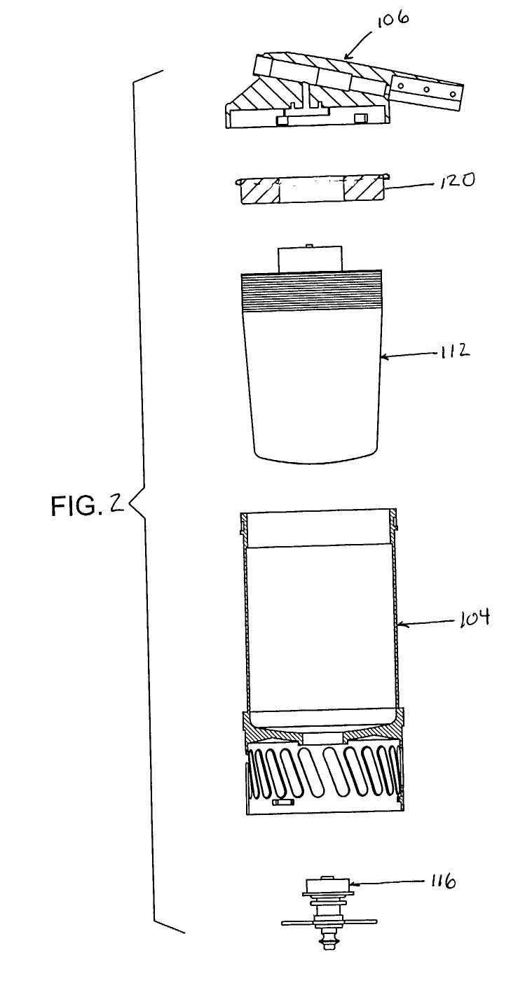

FIG. 2 is an exploded view of the sprayer 102 showing the manner in which the spray assembly 106, a seal 120, the housing 104, and the container 112 fit together with the fluid container 112 accepted within the vessel of the housing 104 and the spray gun assembly coupled to the top of the housing 104.

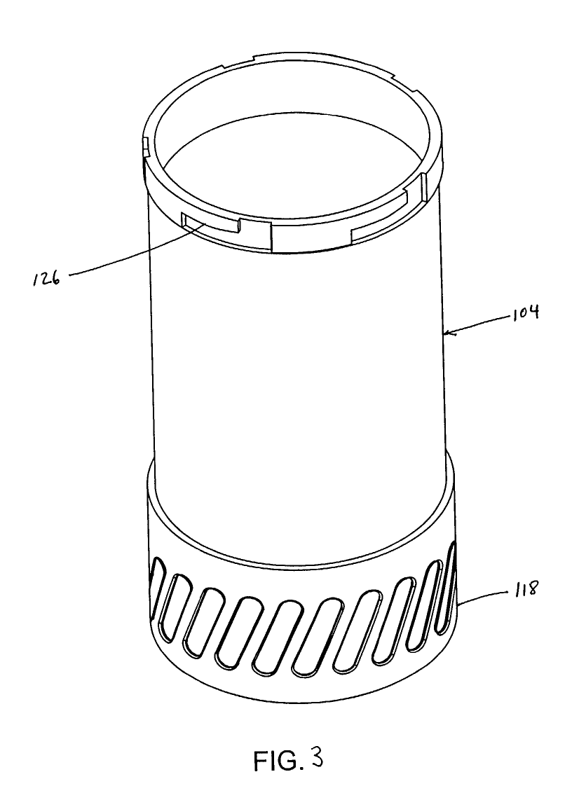

FIG. 3 is a perspective view of an embodiment of the housing 104. The material used to fabricate the housing 104 depends on the intended use of sprayer 102. Acceptable materials for a sprayer 102 intended for spraying typical commercially available paints include aluminum and many kinds of plastic. The housing 104 includes the locking protrusions 122 on the inside surface of the cage 118 already discussed. In addition, locking features 126 near the open end of the housing 104 for use in coupling the housing 104 to the spray assembly 106 are also visible.

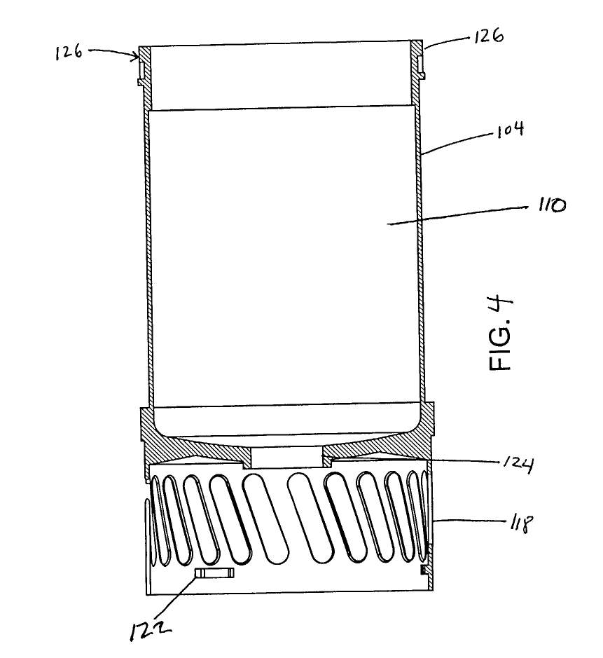

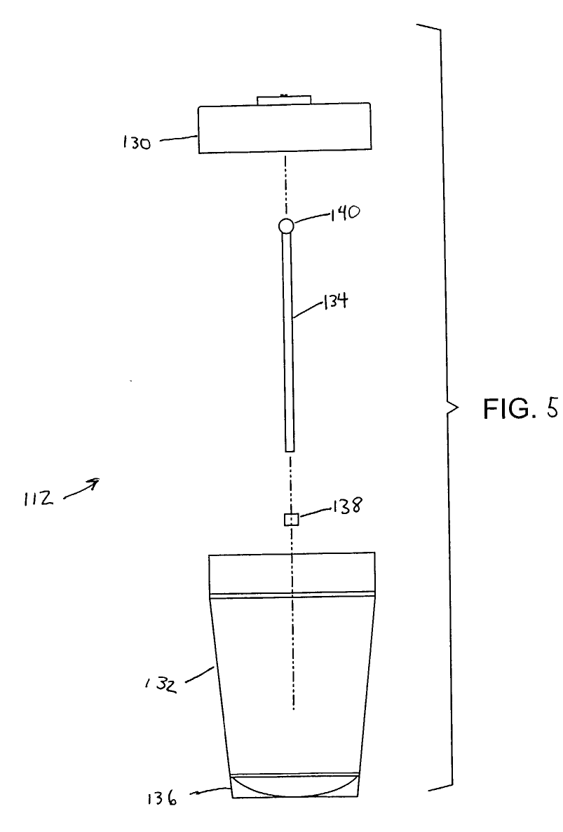

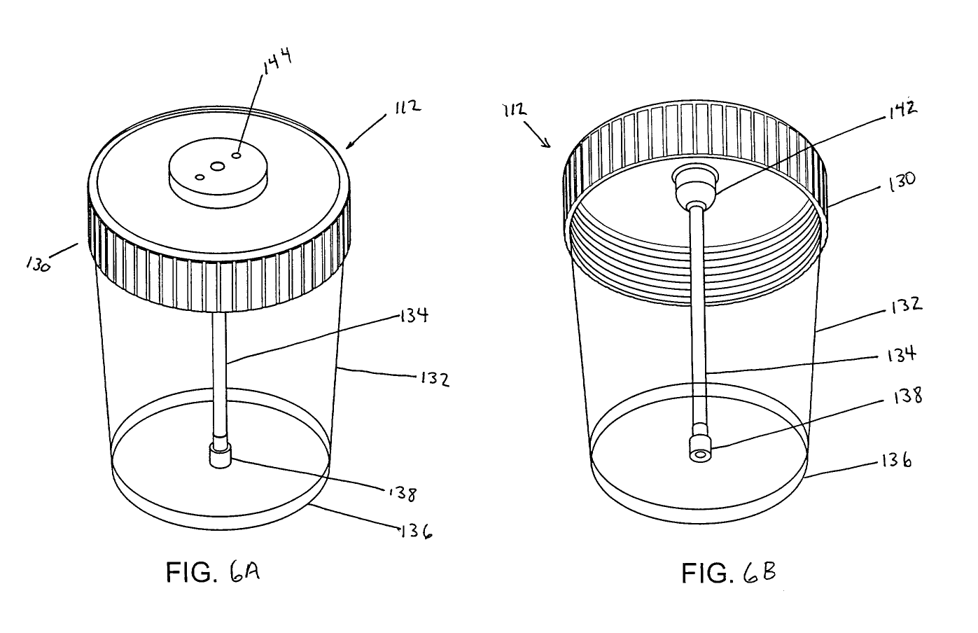

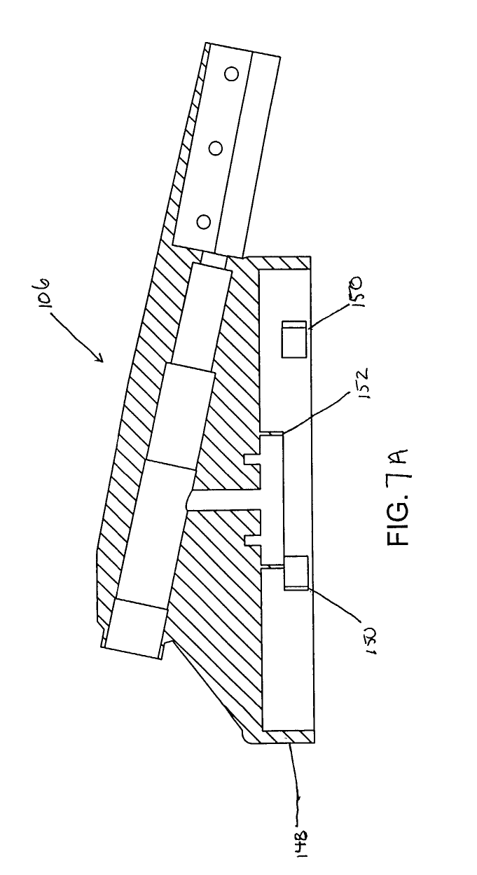

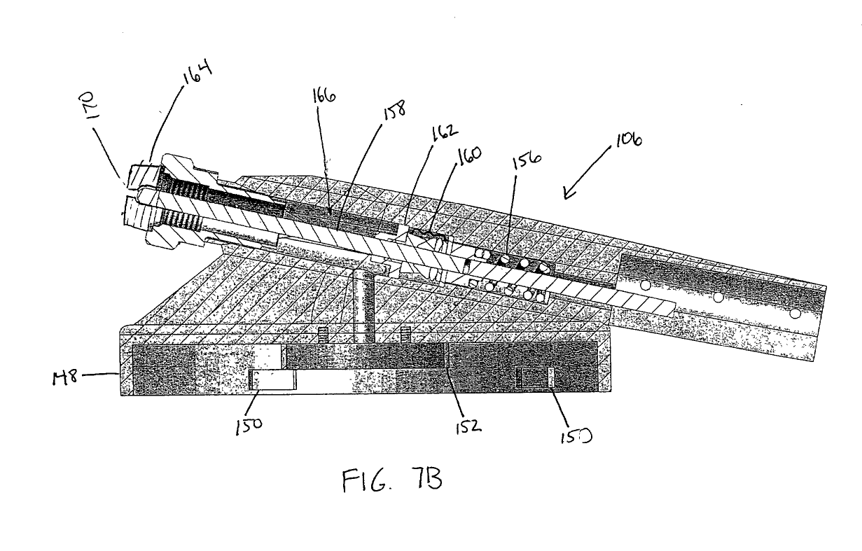

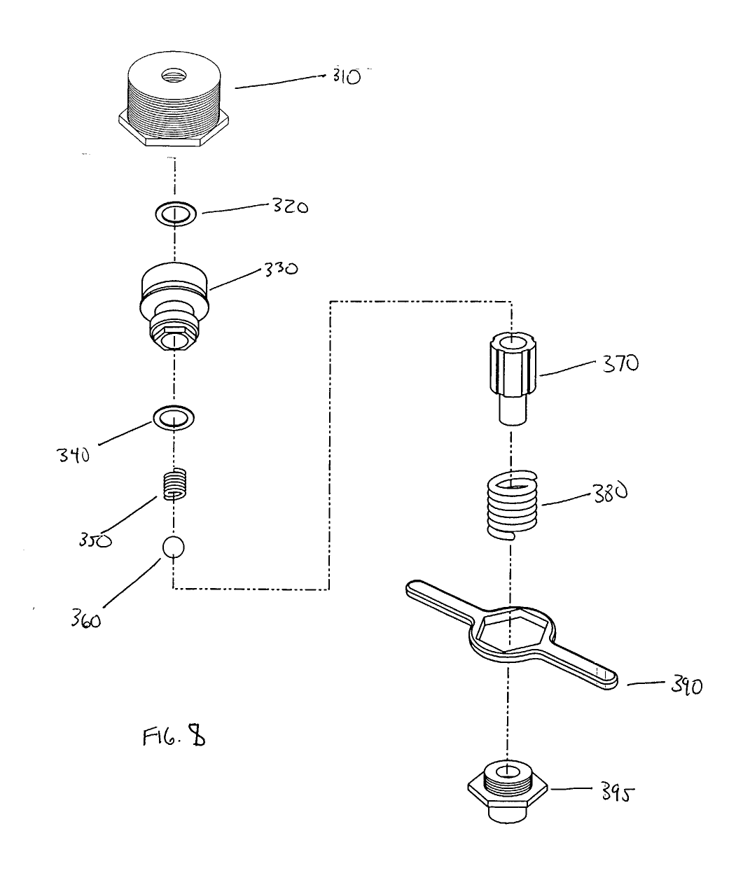

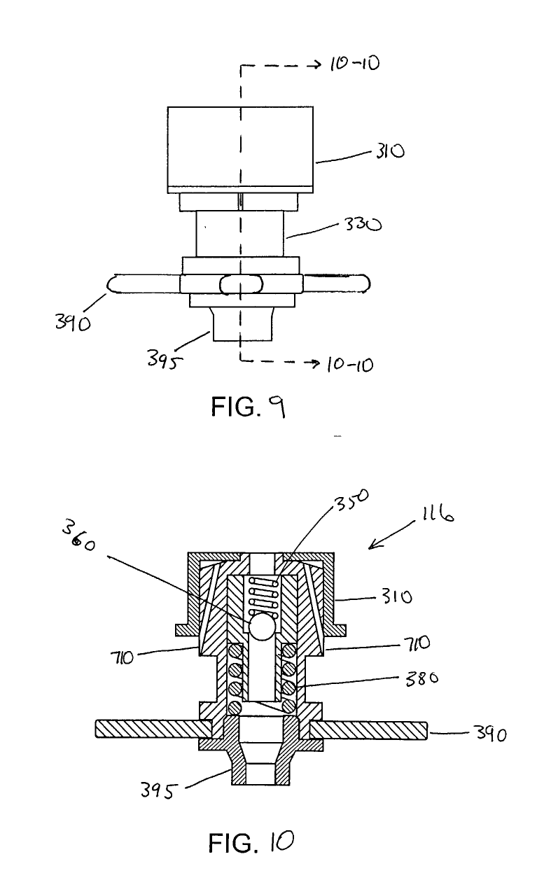

FIG. 4, shows a cutaway side view of the housing 104. As has been discussed, a flange or cage 118 surrounds the lower outer perimeter of the housing 104 and extends downward from the bottom of the housing 104 to protect the three-way valve 116. Locking protrusions 122 are formed on the inner surface of the cage 118 as shown. These are intended to interact with features on the pump 114 allow the sprayer 102 to be removably couplet to the pump. Aperture 124 I the bottom of the pressure chamber 110 is sized to accept three-way valve 116. The aperture 124 may be threaded, or in alternate embodiments, other known means for fixing the valve 116 to the housing 104 may be used.

FIGS. 5 and 6a and 6b show a preferred embodiment of the fluid container 112. Referring to FIG. 5, the container 112 is preferably re-useable and replaceable so that the fluid being sprayed may be easily switched by simply switching the container 112. In some embodiments the container 112 may be disposable. The container 112 is preferably fabricated from plastic, but in alternate embodiments, many other materials may be acceptable.

The fluid container 112 preferably includes a lid 130 that is threadably coupled to the cup 132 of the container. A siphon tube 134 extends into the cup 132 and is used to deliver fluid to the to the spray assembly 106. The siphon tube 134 is preferably able to flex, swivel, or pivot in response to gravity so that it always points towards the ground, and may include a filter tip 138 as seen in FIG. 5. As is seen in FIG. 6B, a ball 140 on the end of the siphon tube 134 is held by a pivot fixture 142 on the underside of the lid 130. The swivel allows the end of the siphon to remain as the deepest part of the container 112 when it is tipped. The bottom of the container is preferably concave so that the tip of the siphon tube 134 remains near the bottom wall of the container 112 as it swivels. In alternate embodiments, other known means for allowing the siphon tube 134 to pivot or flex may be used. The cup flange 136 surrounding the outer perimeter of the rounded bottom of the cup 132 of the container 112 extends at least as far as the center of the rounded bottom. This allows the container 112 to stand on a level surface. The lid 130 further includes a two-way valve 144, best seen in FIG. 6B, that equalizes the air pressure inside the fluid container 112 and outside the fluid container 112. Although a preferred configuration of the fluid container 112 has been shown, many other embodiments of the fluid container 112 may be useable in the invention.

Referring FIGS. 7A and 7B, in most embodiments, the spray assembly 106 preferably comprises a packing 166 (best seen in FIG. 7B) for dispensing the fluid, a trigger assembly (not shown) that actuates the packing assembly, and a handle (not shown) that is coupled to back end of the spray assembly 106, and a lid portion 148. The spray assembly 106 also normally includes a spray nozzle 164. Many varieties of spray nozzles 164 are available commercially, and many such spray tips may be useable. The spray nozzle 164 may also be changed depending on the material to be sprayed and the pressure with which the material will be sprayed.

The packing 166 comprises the mechanism for controlling the fluid flow leaving the spray assembly 106. FIG. 7B discloses a packing 166 comprising a rod 158, the tip of which engages the nozzle to control fluid flow, a packing nut 162 that centers the rod and separates the other elements of the packing from the fluid flow, seal means 160, spring 156, which acts on the rod to urge the tip of the rod to engage the aperture 170 in the nozzle 164. In use, a trigger mechanism, when actuated, pulls the rod 158 back, overcoming the resistance of spring 158, allowing fluid to escape through the aperture 170 of nozzle 164. Many kinds of useable trigger assemblies are well known in the art and commercially available, and one skilled in the art could easily select an appropriate trigger assembly.

Many varieties of packing mechanisms are available commercially, and other such packing mechanisms may be useable. Many of the existing packing mechanisms place packing elements near the nozzle. The packing 166 shown in FIG. 7B has the advantage that fluid does not contact any of the working parts of the packing except the rod 164, thus, the packing mechanism shown in FIG. 7B may, have the advantage of being easier to clean.

A handle, also not shown in the figures, is attached to the end of the trigger assembly opposite the spray nozzle. Many kinds of useable handles are well known in the art and commercially available, and one skilled in the art could easily select an appropriate handle. The handle may be any desired shape, but in most embodiments, is preferably configured to be held in one hand, and is preferably formed of a rubberized epoxy.

The spray gun assembly also includes a lid portion 140. The inner perimeter of the lid portion 140 includes protrusions or pins 150 that complement the locking features 126 on the outer surface of the open end of the housing 104. The pins 150 are preferably made of steel, but could be made of other materials, including aluminum, in alternate embodiments. The lid 148 is placed over the open end of the housing 104 and rotated until seated and locked in place. In other embodiments alternate known means for coupling the lid 148 to the housing 104 may be used. A cylindrical ring 152 extends from the underside of the lid 148 and engages the lid 130 of the container 112, allowing fluid access to the spray assembly 106.

Some embodiments of the invention use a single three-way valve 116 rather than separate pump coupling, pressure release, and a safety valves. An example three-way valve 116 configuration will be discussed that allows fluid flow in one direction primarily, but that will automatically allow fluid to flow in the opposite direction if there is a sufficient pressure. In addition, the valve may be opened manually. FIG. 8 illustrates an exploded view of one embodiment of the three-way valve. The main components are the mount 310, outer seal 320, outer housing 330, inner seal 340, inner coil 350, ball 360, inner housing 370, outer coil 380, manual knob 390, and nipple 395. In the embodiment shown, the mount 310 has external and internal threads and a large opening at one end, and a smaller opening at the opposite end.

FIG. 9 illustrates a side view of one embodiment of the valve 116. FIG. 10 illustrates a cross-sectional view taken along line 10-10 of FIG. 9. The ball 360 and inner coil 350 sit within the inner housing 370, and the outer coil 380 surrounds the bottom section of the inner housing 370, and rests on the surface surrounding the large opening of the nipple 395. The manual knob 390 fits around the hexagonal structure of the outer housing 330.

The outer housing 330 is threaded on the exterior surface to fit within the mount 310, through the mount's large opening. It is also internally threaded to accept the nipple 395. The outer housing 330 has vertically oriented vents 710 (best seen in FIG. 10) for allowing a fluid to flow from the inside of the mount 310 to the outside of the valve when the outer housing 330 is loosened from the mount 310. The outer housing 330 has a hollow interior with a large opening on one end and a smaller opening on the opposite end of the outer housing 104. The outer housing 330 has internal threads positioned within the hollow interior of the outer housing 330 adjacent the large opening.

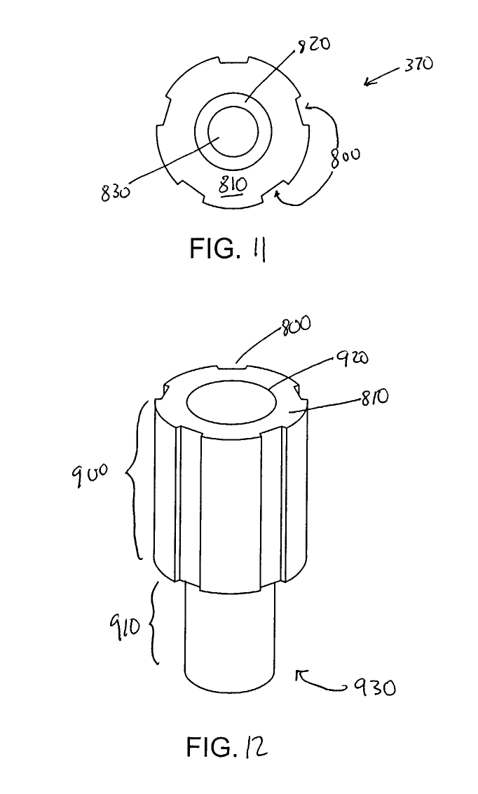

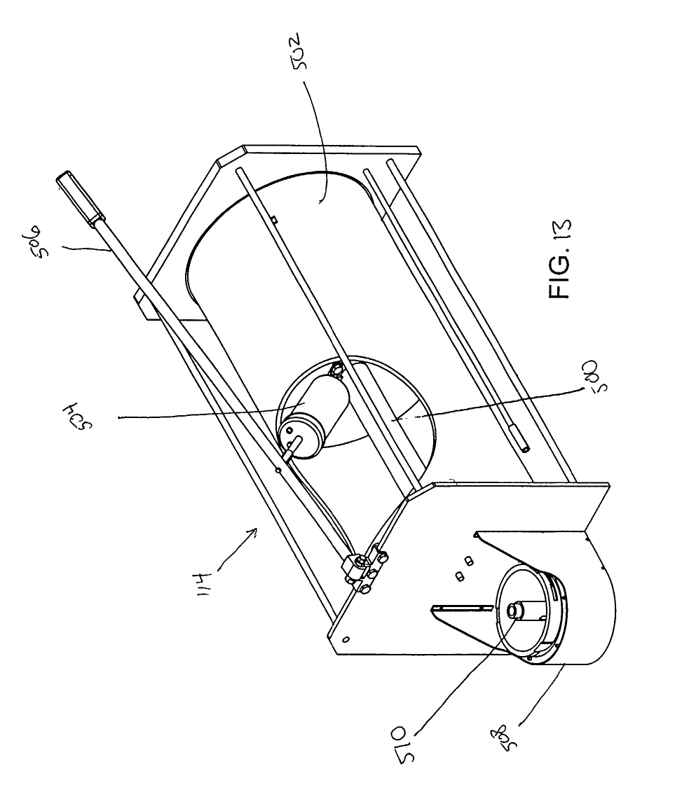

FIG. 11 is a top view of one embodiment of the inner housing 370 of the present invention. FIG. 12 is a perspective view of one embodiment of the inner housing 370. The inner housing 370 has a top section 900 with an interior surface, an exterior surface, and a top surface 810. The inner housing 370 also has a bottom section 910 having an interior surface, an exterior surface, a top surface 820 and a bottom surface. The top section 900 has a hollow interior 920 dimensioned to accept the ball 360 and inner coil 350. The bottom section 910 has a hollow interior 830 in fluid communication with the top section's hollow interior 920 and that is smaller than the hollow interior 920 of the top section 900. The ball forms a movable seal between the hollow interior of the top 900 and bottom 910 sections, the ball resting on the bottom section's top surface 820. The inner seal 340 rests on the top section's top surface 810. The bottom section 910 has a smaller exterior surface than the exterior surface of the top portion 900. The top section 900 of the inner housing 370 has vents 800 to allow a fluid to flow from inside the outer housing 330 to outside of the valve when pressure on the ball 360 forces the inner housing 370 away from the inner seal 340.

The invention may also include a separate two-stage pump configured to allow pumping of air under high pressure into the pressure chamber in the housing of the sprayer. The pump assembly is preferably manually operated, but could be powered in alternate embodiments. Known manual pumps may require significant exertion to pressurize the volume of air necessary to operate the sprayer at high pressures. The pump disclosed herein allows the generation of the required pressure with much less exertion by the user.

Referring to FIG. 13, the pump 114 that generally comprises the following major components, an air compression chamber 502, a manual air pump 504 for pumping air into the air compression chamber 502, and a pneumatic piston (within the air compression chamber 502) powered by the pneumatic cylinder 500 for crushing the air in the compression chamber and transferring the highly pressurized air to the sprayer 102. In general many possible configurations of the pump 114 are useable. Although a two-step manual pump 114 means is described, it will be clear to one skilled in the art that many other means for achieving the desired air pressure are possible.

In the embodiment disclosed, a single lever 506 is used for pumping both the air into the compression chamber and for operating the pneumatic cylinder that pushes the pneumatic piston. The pump 114 also includes a means for switching between the air pump 504 and the pneumatic piston, a pressure gage (not shown), and a cradle 508 for accepting the sprayer 102. The air pump 504 can be seen as a volume multiplier for the pneumatic piston. By initially pressurizing the air in the compression chamber 502 using an air pump 114, the size of the compression chamber 502 may be minimized, and the final compression maybe accomplished with a single cycle of the pneumatic piston. Using the pneumatic piston for the final compression allows the achievement of greater air pressure than would be easily attainable, manually, with the use of the air pump 504 alone. Also, by first increasing the air pressure using the air pump 504, a single cycle of the pneumatic piston may be sufficient to charge the air sprayer for operation at high pressure, which may significantly increase the speed at which the sprayer 102 can be charged with air pressure. If the air pump 504 is not used, multiple cycles of the pneumatic piston would be require. The pump 114 can preferably provide air pressure above 300 psi, and more preferably, above 1,000 psi, and most preferably above 2,000 psi.

The cradle includes a valve 510 in fluid communication with the compression chamber 502 which couples to the three-way valve 116 on the bottom of the housing 104 of the sprayer 102. This allows air from the pump 114 to enter the pressure chamber 110 of the sprayer 102. The cradle also includes some means for interacting with the locking protrusions 122 on the housing 104 in order to lock the sprayer 102 into position during pumping.

In operation, the user first actuates the pump so that the lever operates the air pump 504. The air pump 504 pumps air into the compression chamber. Pumping the air pump 504 at low pressures is easy, efficient, and can quickly increase the air pressure in the cylinder. However, Generally, at between 15 and 80 psi, manual operation of the air pump becomes inefficient or tiresome to the user. In some embodiments air pump 504 is configured so that this pressure may be reached with 10 cycles or less of the air pump 504.

Next, the operation of the pump 114 is switched so that the pneumatic piston is actuated. The operator uses the lever to compress fluid in the pneumatic cylinder 500 to move the pneumatic piston in order to reduce the volume in the compression chamber 502. Highly compressed air travels through a tube to the valve 510 coupled to the three-way valve 116 and into the sprayer 102. The volume of the compression chamber 502 may be selected so that the maximum allowable pressure is reached when the pneumatic piston has substantially reduced the volume of the compression chamber 502.

The air pressure may also be selected by stopping the piston when the desired pressure has been reached. The pressure can be monitored using a gage on the pump 114 or a the gage on the sprayer 102.

When the desired operating pressure has been reached, the remaining pressure may be released from the pump 114 assembly, and the sprayer 102 may be disconnected for use.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A portable pressurizable fluid spray system comprising:
a spray assembly, and a pump assembly,
said spray assembly comprising a housing capable of coupling to said pump assembly, said housing defining a pressure chamber, said housing further comprising a pump coupling in gas communication with said pressure chamber; a fluid container configured to be received within said pressure chamber, said fluid container having a top and a bottom, said top of said fluid container including a first opening and a siphon extending from said first opening into said fluid container; a spray gun assembly coupled to the top of the paint housing 104, the spray gun assembly being in fluid communication with the fluid conduit.
said pump assembly comprising a compression chamber, a means for pumping air into said pumping chamber, and a means for reducing the size of said pumping chamber.
